(19) United States
(12) Patent Application Publication
(10) Pub. No.: US 2003/0106057 A1
(43) Pub. Date: Jun. 5, 2003

(54) Television navigation program guide

(75) Inventor: Albert Honey Perdon, Cerritos, CA (US)

Correspondence Address: HALE AND DORR, LLP, 60 STATE STREET, BOSTON, MA, 02109

(73) Assignee: Predictive Networks, Inc., Cambridge, MA (US)

(21) Appl. No.: 10/004,565

(22) Filed: Dec. 5, 2001

(51) Int. Cl. H04N 5/445; G06F 3/00; G06F 13/00; H04N 5/45

(52) U.S. Cl. 725/45; 348/563; 348/564; 348/565; 725/43

(57) ABSTRACT

An interactive television program guide and method using the guide. Under one aspect, the program guide features a layout having a plurality of sectors of program information, with each sector in the layout relating to a different genre of program information. Each sector in the layout extends from a generally central area of the layout to a generally peripheral area of the layout. Each sector includes a cell to display one or more program listings. The program guide also features an indicator that one of the cells in the layout is selected. A user of the program guide can pan between program listings within a single sector and can also pan between sectors to navigate through the program guide.

### FIELD

The present invention relates generally to an interactive television program guide using a sector system and, more generally, to a program guide organized in a non-linear, user friendly manner.

### BACKGROUND OF THE INVENTION

Broadcast television systems typically provide a large number of television channels to be viewed by viewers. Typically, viewers have been able to consult a printed television guide to determine which programs can be viewed on particular channels or networks. In addition, one or more channels have been provided that present television schedules. These televisions schedules are typically presented in a grid format with columns and rows. Each row represents a different channel, each column represents a different time, and the grid contains programs that can be viewed on the different channels at different times. The rows of the grid scroll over the television screen so that all of the channels can eventually be viewed.

Interactive television programs guides generally allow the viewer to navigate through the grid of columns and rows described above using a remote control. Typically, the user can scroll up or down to view different channels in the rows of the grid, and the user can also scroll to the left or right to view programs that are available at different times. The grid is typically organized in a linear manner to allow navigation as described above.

The current navigation system and layout for television programs guides described above often makes it difficult for a television viewer to navigate from channel to channel without having to move through a number of channels in which the viewer is not interested. For instance, a viewer may have to scroll up or down thirty-five channels to navigate between the viewer's two favorite channels.

### SUMMARY OF THE INVENTION

The invention features an interactive television program guide. Under one aspect of the invention, the program guide features a layout having a plurality of sectors of program information, with each sector in the layout relating to a different genre of program information. Each sector in the layout extends from a generally central area of the layout to a generally peripheral area of the layout. Each sector includes a cell to display one or more program listings. The program guide also features an indicator that one of the cells in the layout is selected. A user of the program guide can pan between program listings within a single sector and can also pan between sectors to navigate through the program guide.

Under another aspect of the invention, an apparatus for presenting program information on a monitor is provided. The apparatus features circuitry to receive program information and present a television guide. The television guide includes a layout having a plurality of sectors of program information, with each sector in the layout relating to a different genre of program information. Each sector has at least one cell displayed therein, and each cell displays a program listing. An indicator shows that one of the cells in the layout is selected.

### BRIEF DESCRIPTION OF THE DRAWINGS

FIG. 1 is a block diagram of a network for use in accordance with an aspect of the invention.

FIG. 2 is a top view of a program guide according to one aspect of the invention.

FIG. 3 shows a number of displays of the program guide of FIG. 2 to illustrate navigation of the program guide.

FIG. 4 shows a number of displays of the program guide of FIG. 2 to illustrate navigation of the program guide.

FIG. 5 shows a number of displays of the program guide of FIG. 2 to illustrate navigation of the program guide.

FIG. 6 is a top view of a program guide according to a second aspect of the invention.

FIG. 7 shows a number of displays of the program guide of FIG. 6 to illustrate navigation of the program guide.

FIG. 8 is a top view of a program guide according to a third aspect of the invention.

FIG. 9 shows a number of displays of the program guide of FIG. 8 to illustrate navigation of the program guide.

FIG. 10 shows a number of displays of the program guide of FIG. 8 to illustrate navigation of the program guide.

### DETAILED DESCRIPTION OF THE EMBODIMENTS OF THE INVENTION

The embodiments described below relate to program guides for navigating program information on a television. Very briefly, the program guide can include a layout having a plurality of sectors of program information, with each sector extending from a generally central area of the layout to a generally peripheral area of the layout. Each sector in the layout can relate to a different genre of program information, and each sector can include a plurality of program listings. A user can navigate through the program listings.

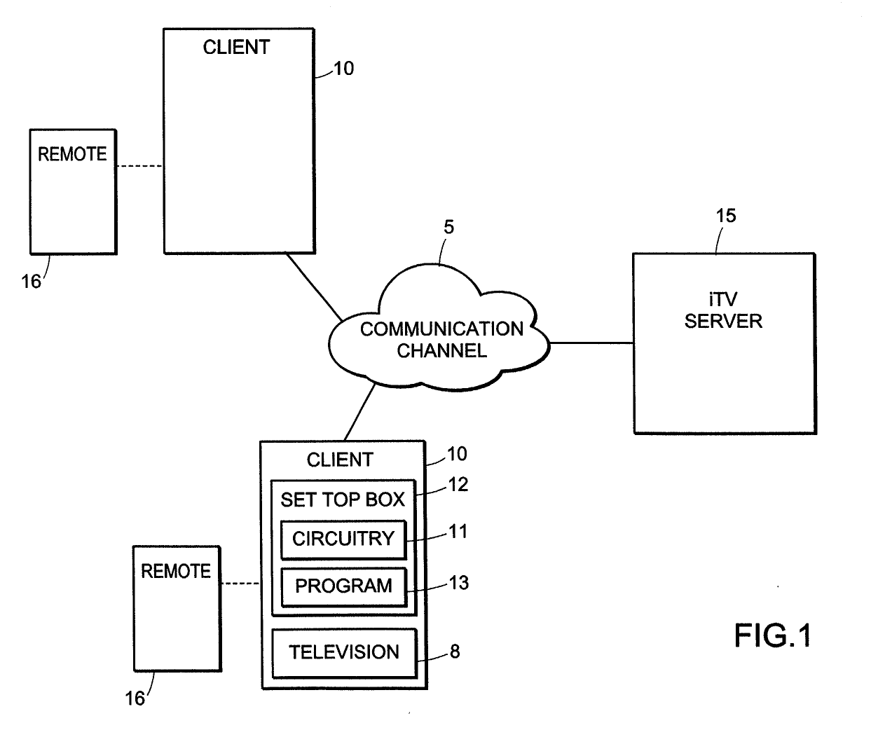

FIG. 1 illustrates a representative network in which the system can be implemented according to one aspect of the invention. The network includes one or more client machines 10 operated by various individual users or television viewers. The client machines 10 connect to an interactive television (iTV) server 15 through a communication channel 5, which can be a broadcast that is relayed to the clients 10 via a cable connection, satellite dish, or the like. The communication channel 5, in some embodiments, includes a back channel of communication for data going upstream from a client 10 to the iTV server 15. Such a back channel of communication, also represented by communication channel 5 in FIG. 1, can be a telephone line or cable modem, and such a back channel of communication allows two-way communication between the clients 10 and the iTV server 15. In another embodiment, the iTV server 15 broadcasts information to the clients 10, but the clients 10 have no way of accessing or providing information back to the iTV server 15.

The iTV server 15 can, in some embodiments, include an ISP server (not shown), to provide interactive content that includes the Internet. Such an iTV server 15 can be provided by a cable operator, such as RCN. Generally, the iTV server 15 can include or be a part of a distribution facility (not shown) to link the iTV server 15 to the communication channel 5 and a data source (not shown) that provides broadcast information, such as television shows, advertisements, and television program guides to the clients 10.

The client machine 10 can be an interactive television set 8 with a set top box 12 or, in other embodiments, a computer. Generally, these client machines 10 can be any type of network device existing for a subscriber. The set top box 12 can be made by Motorola and the operating system may be the OpenTV operating system, although set top boxes 12 made by other entities and other operating systems can also be used. The television 8 itself can be made by any manufacturer, including but not limited to Magnavox, Sony, and Toshiba. A representative interactive television set 8 includes a set top box 12 with a computer processing unit (circuitry 11) and memory (not shown), a remote control 16 or other input device for user interaction, and a display unit (television set). The set top box 10 could also be integrated into the television set.

The screen of the display unit is used to present programs, advertising, and other content to the user. A graphical user interface (GUI) on the display unit can also be available for the user to make programming selections, interact with programs, and access the Internet. The GUI is supported by the operating system and allows the user to use a point and click method of input, e.g., by moving a highlighted area on the display screen to a section representing a program at a particular time and pressing on the remote control buttons to perform a selection. The television guide discussed herein can be presented to the user on the display unit as a GUI. The user can access such a television guide by pressing a “guide” button or similar button on the user input device, such as a remote control unit 16.

In addition to program content, the iTV server 15 provides data regarding program listings, such as program times, channels, titles, and descriptions, that can be used in the television guide. In addition, the iTV server 15 can provide data regarding the genres of the program content. For instance, in one embodiment, the iTV server 15 can provide data regarding the genre (i.e., news, sports, comedy) that generally fits a particular channel. In such an embodiment, the genre of a channel could be fixed. In another embodiment, the iTV server 15 can provide data regarding the genre that fits a particular television program that is or will be broadcast on a particular channel. In such an embodiment, the genre of a particular channel can change with time.

This data regarding program guides can be provided by the iTV server during program transmission. The data can be provided in the vertical blanking interval (VBI) of a television channel, in the data channel of the MPEG stream, or in the data stream of a program guide channel. The set top box 12 typically takes this data and stores it until it is retrieved during a request by the user to display the program guide. The set top box 12, therefore, generally contains circuitry 11 to supply the program guide information that will be displayed on the user's television 8. In some embodiments, the layout of the program guide is supplied to the set top box 12 from the iTV server 15 along with the data regarding program listings. In other embodiments, the set top box 12 contains a module or program 13 along with circuitry 11 to receive the program listings, generate the layout, and then provide that layout with the program listing information to the television screen. In still other embodiments, when a viewer presses a “guide” button, the set top box 12 can transmit a request to the iTV server 15 to deliver a television guide to the set top box 12, and that television guide can then be displayed. The television program guide can be provided by a television service provider through the television distribution system, which provides the television channel programmning to television receivers. Alternatively, the program listings can be developed at a device such as the television set top box 12 at the viewer location.

The genres can be assigned to television channels or particular television programs by the television industry or by an outside rating service, such as Nielsen. These genres can include, for instance, categories such as: arts, cartoons, children's shows, daytime soap-operas, finance, first-run syndication, game shows, health, hobbies and crafts, instructional, movies, music, network series, news, public affairs, religious, specials, sports, syndicated, talk shows, and television movies. Subcategories can also exist. Under the sports category, for instance, subcategories could include basketball, baseball, boxing, extreme sports, and hockey.

In some embodiments, the television program guide can offer recommendations and/or can organize by genre the program information that appears on the program guide. The television program guide can be used with a variety of systems capable of identifying shows expected to be of interest to particular viewers and ranking shows in order of preference. These recommendation systems include, but are not limited to, ranking shows or channels based on shows viewed by the viewer in the past, channels viewed in the past, viewer preferences based on information provided by or for particular viewers, show popularity, show popularity among other viewers with similar profiles, viewing habits or preferences, or demographics of the viewer. The program guide can include a personalized recommended program layout displayed on the user television screen, e.g., on a dedicated channel (which may be a virtual channel to which the viewer tunes). The television program guide can identify the shows expected to be most interesting to the viewer in some time period, e.g., over the next hour or several hours.

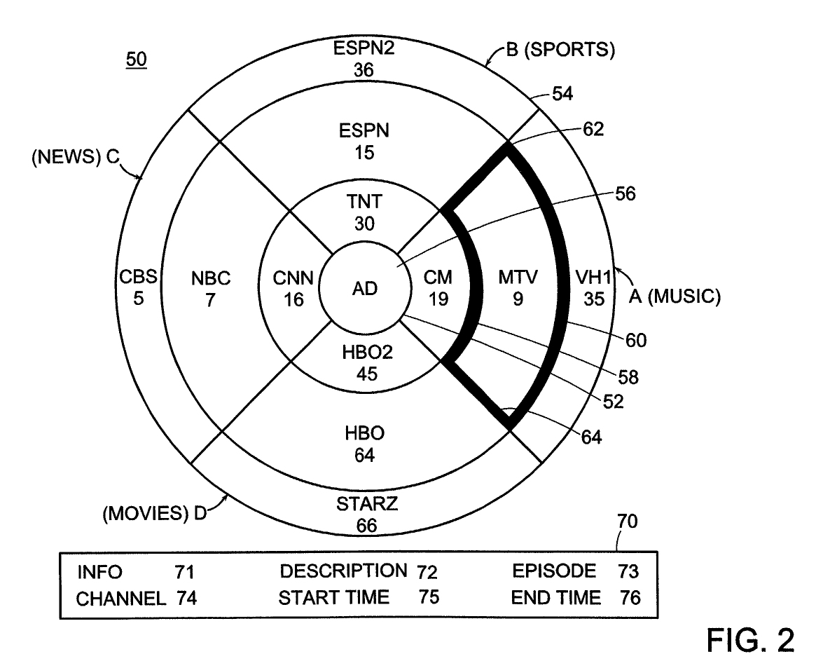

FIG. 2 depicts a first embodiment of a program guide 50 according to an aspect of the invention. The program guide 50 of FIG. 2 has a layout shaped generally like a circular donut that displays a number of sectors A, B, C, D of program information. Each sector A, B, C, D relates to different genres of program information. For example, sector A relates generally to music, sector B relates generally to sports, sector C relates generally to news, and sector D relates generally to music. Each sector, therefore, has program information for shows relating to the genre of that sector.

Each sector A, B, C, D of the program guide 50 contains a number of cells that contain program listings. Sector A, for instance, contains cells for channel 19, channel 9, and channel 35. Each sector A, B, C, D can therefore display the television channel and name of the channel in cells of the sector in one embodiment. In another embodiment, each cell of a sector A, B, C, D relates to program information, such as a specific television show, that is currently on television. For instance, sector B, which relates to the genre of sports, could display in one cell the teams playing a football game, display in another cell a sports news show, and display in a third cell the teams of a basketball game. Each cell, therefore, displays “program information,” which can be channel numbers and names, specific show names, or other descriptive information about programs.

Each sector A, B, C, D of program guide 50 takes up a space extending from a generally central part 52 of the layout to a generally peripheral area 54 of the layout. Program guide 50 contains advertising information, messages, reminders, or live programming in the center 56. In other embodiments, each sector A, B, C, D extends to the center so that there is no ad area in the center 56. Each sector A, B, C, D of program guide 50 is shaped somewhat like a piece of pie, with a narrow center and a wider outer portion. Program guide 50 contains four sectors A, B, C, D, although in other embodiments, any number of sectors could be used. In some embodiments, the program guide 50 could include text that sets forth the genre of the sector A, B, C, D. For instance, the genre “sports” could be listed near peripheral area 54 for sector B.

Program guide 50 is divided up into sectors, each of which represents one genre of programnming. In some embodiments, the user has the ability to change which genres of program information are displayed in each sector through the use of a remote control 16 (FIG. 1) or other input device for user interaction. For example, the user could press a button on the remote control 16 that causes the single sector in which the current selected cell is present to be changed to another genre type. In another embodiment, interaction by the user could cause all of the sectors of the guide to be replaced with new genres, each of which could contain new programming information.

Program guide 50 has a generally circular shape with concentric circles defining the cells within each of the sectors A, B, C, D. In sector A, for instance, a first cell having channel 19 (CM or Country Music Channel) is defined between two concentric circles 52, 58, with one of the circles 52 at a central portion of the layout and a second circle 58 spaced outward from the first circle 52. The cell having channel 19 is also bordered in a radial direction by a line 62 between sector A and sector B, as well as by a second line 64 between sector A and sector D. The cell in sector A having channel 9 (MTV or Music Television) is similarly defined between lines 62, 64 and by concentric circles 58, 60. Finally, the cell in sector A having channel 35 (VH1) is defined by lines 62, 64 and circles 60, 54.

Program guide 50 displays three program listings (channel 19, 9, and 35) in cells of sector A. In other embodiments, more than three cells could be displayed in sector A. In another embodiment, a subset of program listings that fall within a sector could be displayed in that sector. A larger set of program listings that fall within the genre of that sector might not be displayed until the user navigates to display those program listings. For example, ten different program listings could be available for the music genre of sector A. Program guide 50 displays three of the program listings in cells (channel 19, 9, and 35). In order to view the program listings for the remaining seven program listings of sector A, the user could navigate through the program guide 50 in a manner discussed in greater detail below. Each sector, in this embodiment, can only display a subset of the total number of program listings for that sector.

A cell of program guide 50 is defined by boundaries within a sector, and not by the program listing in that cell. The program listing within a particular cell can change. The cells of the program guide 50 define a skeleton of sorts in which program listings can appear.

The television program guide 50 can list the program listings that are expected to be of most interest to the viewer and, in one embodiment, that can be watched in their entirety. For instance, program guide 50 of FIG. 2 could display the program listings for 8 p.m. that are expected to be of the greatest interest to the viewer. The sectors A, B, C, D displayed in program guide 50, therefore, relates to the genres of greatest interest to the user, and each of the sectors A, B, C, D displays the three most interesting program listings for the genre of that sector. Program guide 50 is organized to display those program listings that are expected to be of the greatest interest to the viewer.

A selected cell in program guide 50 is indicated by highlighting, bolding, coloring, or enlarging that cell. Generally, any indicator can be used to show that a certain cell is selected. Program guide 50, for instance, bolds the cell for channel 9 in sector A to indicated that the cell for channel 9 is selected. A “selected cell” is a cell for which an information box 70 is displayed or a cell which the user can select to view by pressing an “enter” button or using a similar command.

Program guide 50 includes an information box 70 adjacent to the layout of the program guide 50. This information box 70 displays information about the program listing or channel of the selected cell. Information box 70, for instance, includes general information 71 about the program listing, a description 72 of the program listing, an episode name or number 73, the channel number 74, a start time 75 of the program, and an end time 76 of the program.

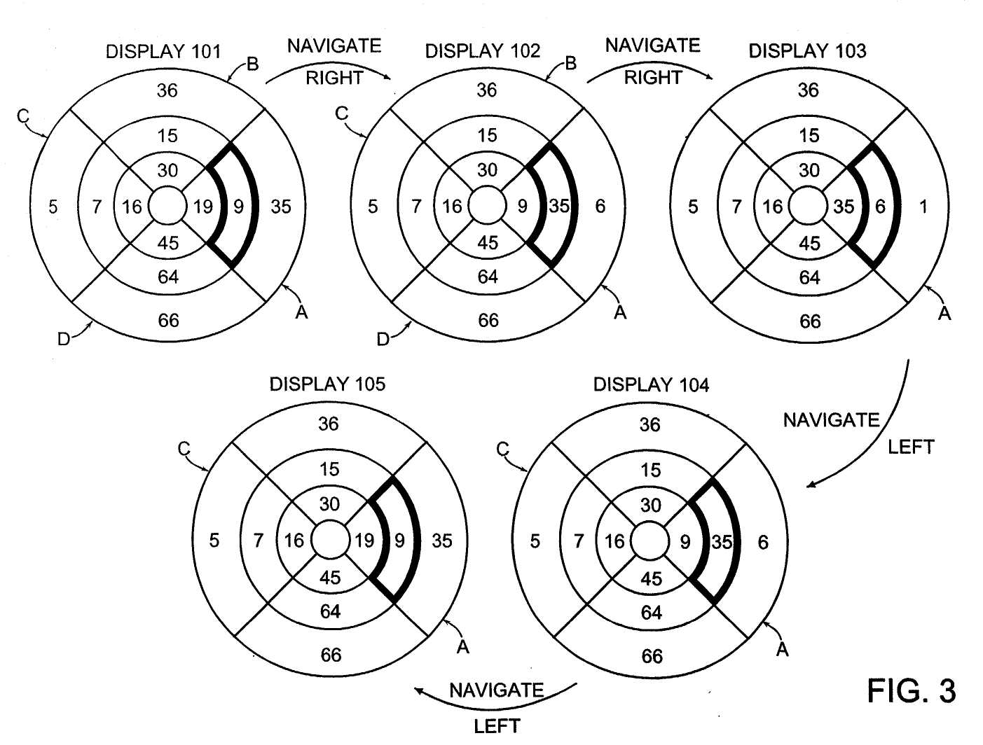

The navigation of program guide 50 of FIG. 2 will now be described with reference to FIG. 3. FIG. 3 depicts five program guides, and the navigation between program listings or channels will be described beginning in the upper left of FIG. 3. In FIG. 3, the program listings in each cell are depicted as channel numbers for ease of description. The cells could, instead, contain program information of other varieties, such as program names, as discussed above. In addition, FIG. 3 does not depict the information box 70 of FIG. 2, which displays more detailed information for the selected cell. This information box 70 is left out of FIG. 3 for ease of description.

Display 101 in the upper left hand comer of FIG. 3 shows the cell having channel 9 selected within sector A. As described above, the user can navigate the program guide using a remote control or other input device for user interaction, and the following description will reference a remote control. If the user navigates to the right, display 102 in the upper center of FIG. 3 results. The highlighted cell stays within sector A, and the channels within sector A rotate. Referring to display 101, channel 35 is immediately to the right of channel 9, which is the highlighted cell. When the user navigates to the right, channel 35 moves to the cell where channel 9 appeared, and display 102 results. Channel 9 has shifted one cell to the left, channel 19 has been removed from display 102, and new channel 6 appears in the cell where channel 35 appeared in display 101. Because the user navigated within sector A, sectors B, C, and D remain the same in display 102 as they were in display 101. Sector A contains more channels (or program listings) than the three available cells that can be displayed in program guide 40. For this reason, new channel 6 in display 102 is displayed in the cell where channel 35 had appeared in display 101, and channel 19 from display 101 is removed from display 102.

When the user navigates to the right again, display 103 appears. A similar shift of channels results so that channel 6, which was immediately to the right of channel 35 in display 102, becomes the highlighted channel and moves into the cell where channel 35 appeared in display 102. Channel 9, which is displayed in 102, moves off display 103, and new channel 1 appears. Once again, sectors B, C, and D remain unaffected by this navigation.

If display 103 is shown and the user navigates to the left, display 104 results. The selected cell remains within sector A. A shift in channels results so that channel 35, which was to the left of channel 6 in display 104, appears in the selected cell in display 104. Display 104 is therefore the same as display 102, with channel 35 from sector A in the selected cell. If the user of display 104 navigates to the left, display 105 results. A similar shift in displayed channels results so that channel 9, which was to the left of channel 35 in display 104, is in the selected cell in display 105. Display 105 therefore appears the same as display 101. In FIG. 3, when the user navigates toward the periphery, the selected cell remains in the same sector and only the channel in the selected cell changes. In addition, if the user navigates toward the center, the selected cell remains in the same sector and the selected channel changes.

In the displays shown in FIG. 3, the highlighted cell remains in one of four cells, with these four cells being distributed between the four sectors A, B, C, D. The middle cell of each sector A, B, C, D can be the highlighted cell. Because one of these cells can be the highlighted cell, these four cells can be larger than the other cells. FIG. 2, for instance, shows that the cell with channel 9 in sector A, the cell with channel 15 in sector B, the cell with channel 7 in sector C, and the cell with channel 64 in sector D are larger than the other cells.

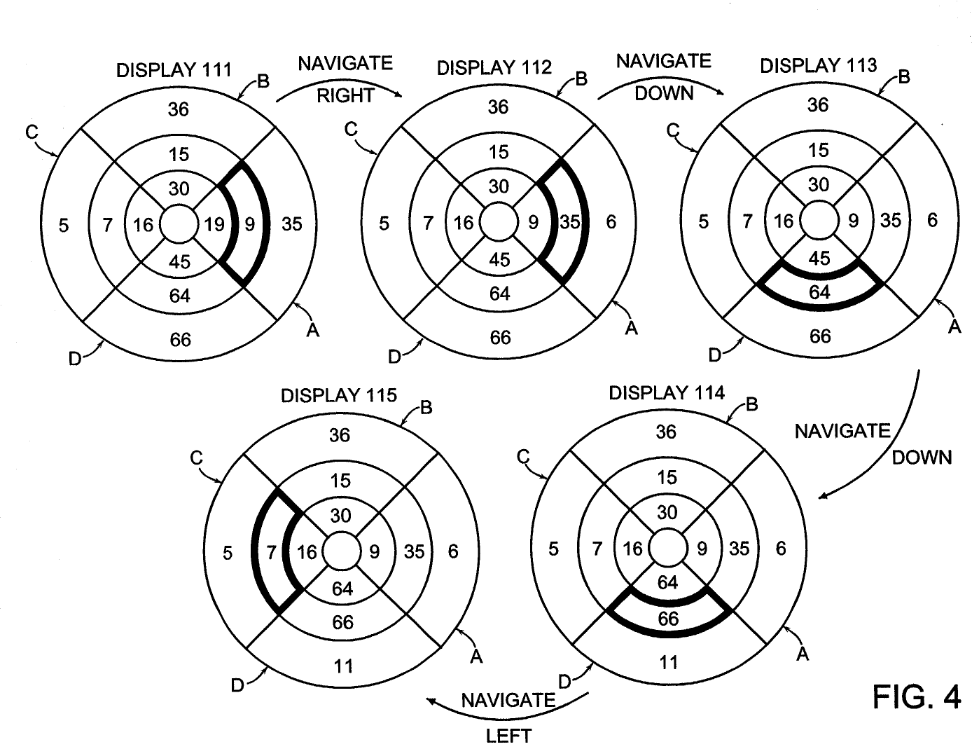

FIG. 4 shows more examples of the navigation of program guide 50 in some embodiments. Display 111 in the upper right of FIG. 4 shows the cell with channel 9 in sector A selected. When the user navigates to the right, channel 35, which was to the right of channel 9, moves into the selected cell and display 112 results, as in the embodiment shown in FIG. 3. If the user of display 112 navigates down, the selected cell moves to within sector D, which is adjacent to and below sector A. The selected cell rotates to within sector D, and channel 64 (in the middle cell of sector D) becomes selected. FIG. 4 therefore illustrates how the user can navigate to change sectors in the program guide 50.

If the user of display 113 navigates down again, display 114 appears. The selected cell remains within sector D, and the channels within sector D rotate. Once again, sector D contains more channels than can be displayed at one time, and a new channel, channel 11, therefore appears in display 114. Channel 66, which was below channel 64 in display 113, moves into the selected cell when the user navigates down, and channel 64 moves up one cell.

The user of display 114 can continue to pan through the channels within sector D, or the user can pan over to one of the other sectors A, B, C to highlight a different cell within one of sectors A, B, C. If the user of display 114 navigates to the left, display 115 results. Sector C, which is adjacent to and to the left of sector D, contains the highlighted cell. The middle cell of display 115, which contains channel 7, becomes the highlighted cell.

As has been shown in FIGS. 3 and 4, the user of program guide 50 can pan between cells within one of the sectors A, B, C, D so that a different channel within that sector becomes the selected channel. In addition, the user can pan between different sectors in the layout to view program information for different genres. In the embodiments of FIGS. 3 and 4, the selected cell remains within the middle ring of the display. If the user navigates toward the center or toward the periphery, the selected cell does not change, but the channels scroll within the sector with the selected cell so that a new channel will be selected.

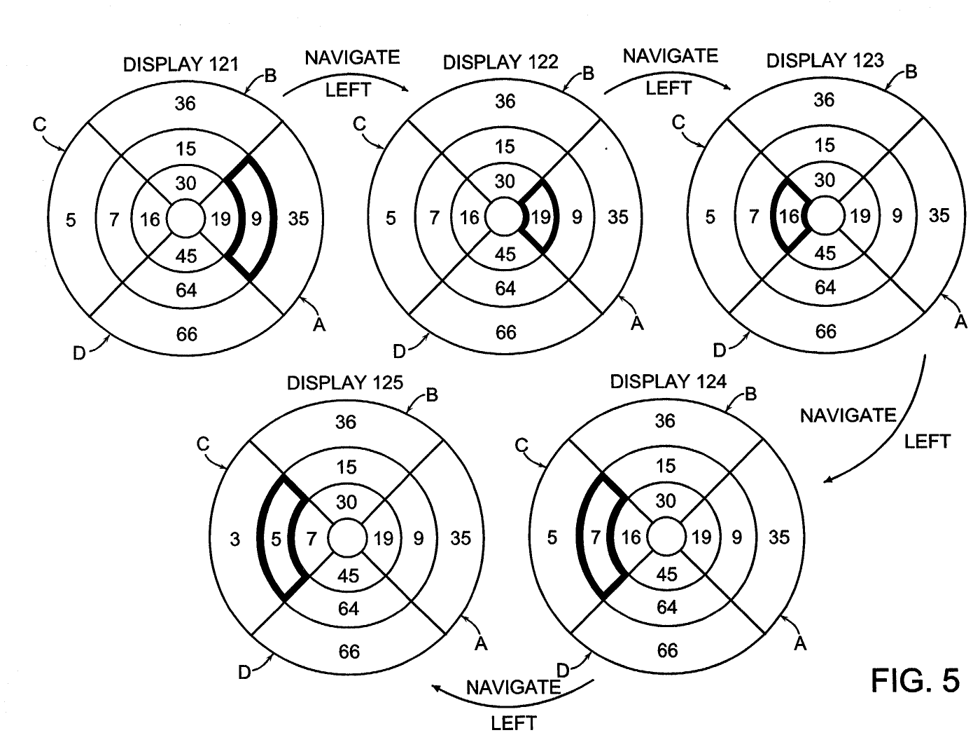

FIG. 5 displays another embodiment of navigation of the program guide 50. In this embodiment, the highlighted cell within each sector can be changed when the user navigates. For instance, display 121 in the upper left of FIG. 5 shows the cell with channel 9 within sector A as being selected. When the user navigates to the left, the sector with the selected cell does not change in this embodiment. In FIG. 3, when the user of display 103 navigates to the left, the highlighted sector changes and display 104 results. In FIG. 5, display 122 shows that only the selected cell changes. The cell with channel 19, which is immediately to the left of the cell with channel 9, becomes the selected cell, and the selected cell remains within sector A. Thus, no new channel appears in display 122 compared to display 121.

If the user of display 122 navigates to the left again, the selected cell moves to the left again, and display 123 of FIG. 5 results. In this embodiment, the sector changes so that the cell with channel 16 in sector C becomes highlighted. If the user of display 123 navigates to the left once more, the highlighted cell changes once again and the cell with channel 7 in display 124 becomes selected. Thus, the series of left navigations beginning with display 121 and ending with display 124 moved the selected cell to the left, but the actually channels displayed in each of the cells of the displays 121, 122, 123, and 124 did not change.

If the user of display 124 navigates to the left once again, the highlighted cell does not change, but the channels move to the right so that channel 5, which is to the left of channel 7 in display 124, becomes the selected channel in display 125. New channel 3 appears in display 125 in the cell in which channel 5 appeared in display 124. In FIG. 5, therefore, navigating outward toward the periphery from the center cell of each sector (the cell with channel 7 for display 124) causes the channels to scroll without a change in the selected cell. As can be seen between displays 122 and 123, on the other hand, navigation toward the center from an inner cell in a sector (the cell with channel 19 in display 122) results in a change in sectors.

In another embodiment (not shown in the Figures), the user can remain within a sector whenever the user scrolls toward the center or periphery of the display. If the user is in the inner cell of a sector and scrolls toward the center, the channels could shift so that a new channel could appear within the inner cell. Similarly, if the user is in an outer cell and navigates toward the periphery, the channels could shift so that a new channel could appear within the outer cell. In order to shift sectors, therefore, the user would need to navigate in a tangential direction to the center of the display. For instance, in display 125 of FIG. 5, the user could navigate up or down to change to sector B or sector D respectively.

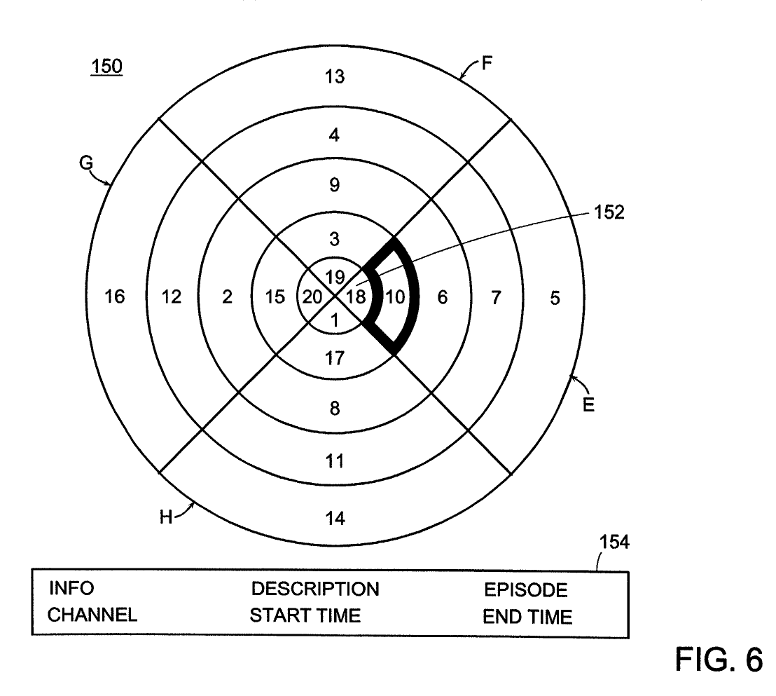

FIG. 6 displays another program guide 150 according to an aspect of the invention. The program guide 150 is similar to the program guide 50 of FIG. 2, except program guide 150 contains more cells. Like program guide 50, program guide 150 contains four sectors E, F, G, H, each of which can contain program information relating to different genres. Unlike program guide 50, program guide 150 does not contain information, such as advertisements, in a center area 152. Instead, program guide 150 contains cells within each sector E, F, G, H that intersect in the center 152. Program guide 150 has a layout that allows five different program listings to be displayed within five cells of each sector E, F, G, H. Program guide 150 also contains an information box 154 that contains various information about the selected program listing.

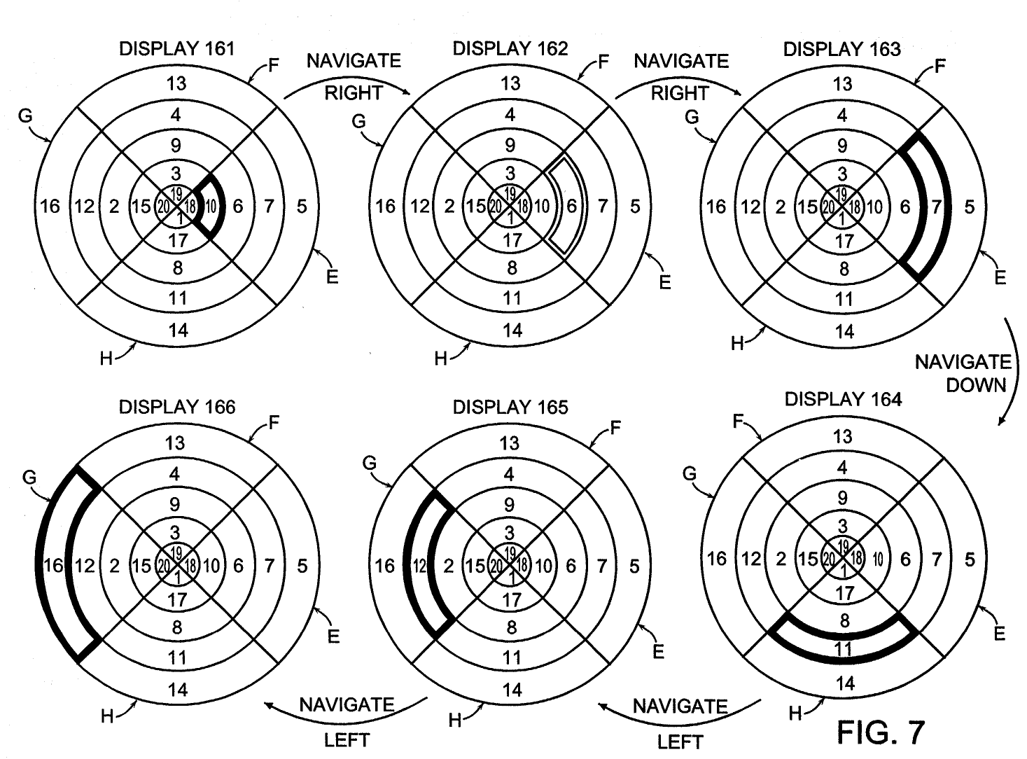

FIG. 7 displays the navigation of program guide 150 of FIG. 6 according to one embodiment. Display 161 in the upper left shows that the cell with channel 10 within sector E is selected. If the user of display 161 navigates to the right, the selected cell shifts one cell to the right and display 162 results. In display 162, the cell with channel 6 is selected. In addition, all of the channels in display 162 remain in the same cells as for display 161—only the selected cell changes. If the user of display 162 navigates to the right again, the selected cell once more shifts one cell to the right, and the cell with channel 7 is selected as in display 163. Once again, all of the channels in display 163 are in the same position as in display 162, and only the selected cell has changed.

When the user of display 163 navigates down, the selected cell moves from sector E to sector H in the embodiment of FIG. 7. Thus, the cell having channel 11 in sector H becomes selected. This cell is adjacent to and below the cell having channel 7 in sector E. If the user of display 164 navigates to the left, the cell having channel 12 in sector G becomes selected as in display 165. Finally, if the user of display 165 navigates to the left, the cell to the left of the cell having channel 12 becomes selected. Thus, display 166 shows the cell having channel 16 as being selected. Throughout the series of navigations from display 161 to display 166, the locations of channels within cells does not change. Instead, only the selected cell changes.

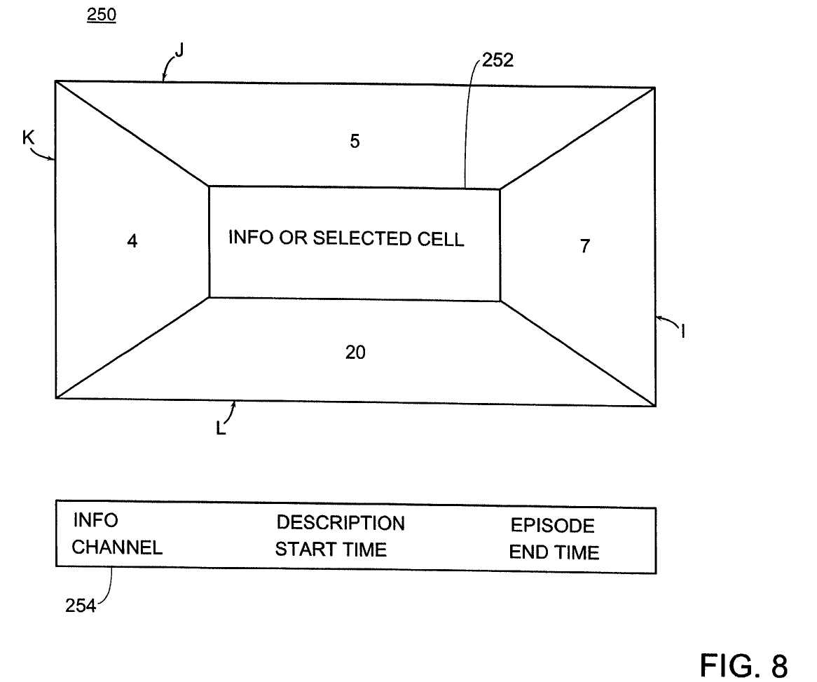

FIG. 8 shows a program guide 250 according to another aspect of the invention. The display of program guide 250 is generally rectangular in shape and contains four sectors I, J, K, L. Each of the four sectors I, J, K, L relates to a different genre of program information. The middle cell 252 can be an information or advertisement cell or, in other embodiments, a selected cell that can contain program information from any of the sectors I, J, K, L, as will be explained in more detail below.

The sectors I, J, K, L of program guide 250 are defined by a space between one of the sides of the center cell 252 and one of the edges of the display. Program guide 250 shows only a single cell within each of the sectors I, J, K, L, although the sectors I, J, K, L could be broken into multiple cells in other embodiments. Program guide 250 also contains an information box 254, which can contain more detailed information about the selected cell of the program guide 250.

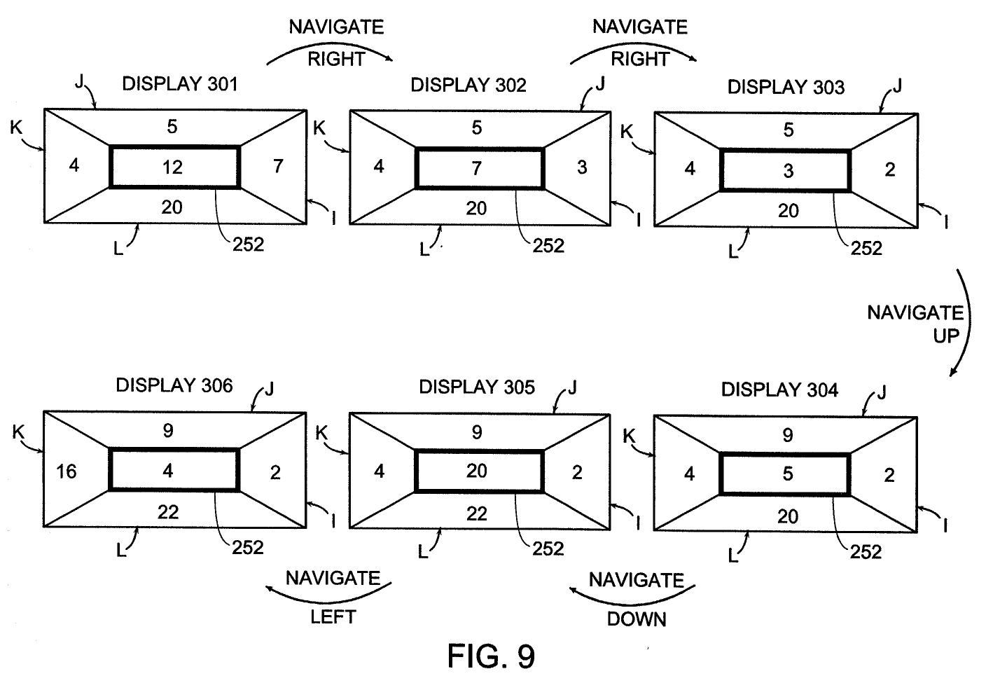

FIG. 9 shows the navigation of one embodiment of the program guide 250 of FIG. 8. In the program guide 250 of FIG. 9, the center cell 252 (display 301) is a dedicated cell that shows the selected channel. This center cell 252 can be considered a cell within each one of the four sectors I, J, K, L. Cell 252 of display 301, which displays information for channel 12, could have program information about any of the four sectors I, J, K, L.

To navigate through program guide 250, the user can navigate left, right, up, or down to select the cell that is to the left, right, top, or bottom of the center cell 252. For instance, to select the cell having channel 7 in sector I from display 301, the user can navigate to the right. The channel in the center cell 252 is replaced by the channel to the right of the center cell 252. Thus, display 302 shows that channel 7, which was to the right of the center cell 252 in display 301, is now selected. Channel 3 is a new channel presented in sector I, and sectors J, K, and L remain unchanged. If the user of display 302 navigates to the right again, display 303 appears. In display 303, channel 3 is in the selected cell, and new channel 2 appears in sector I.

The user can navigate to select channels to the top or bottom of the center cell 242 in the same manner. For instance, the user of display 303 can select channel 5, which is above the center cell 252, by navigating upward. Thus, display 304 shows channel 5 in the center cell 252 and new channel 9 is displayed in sector J. Similarly, the user of display 304 can select channel 20 in sector L by navigating downward. Display 305 shows channel 20 in the center cell 252 and new channel 22 in sector L. Finally, the user of display 305 can select channel 4 from sector K by navigating to the left. Display 306 shows channel 4 in the selected center cell 252 and new channel 16 in sector K.

In another embodiment of the guide shown in FIG. 9, the channel in the center cell 252 could move back to the cell in the sector to which it belongs when the user navigates. As an example of this embodiment, if the user of display 303 navigates up, channel 5 could move to the center cell (as in display 304), and channel 3, which belongs to sector I (see display 302), could move into the cell in sector I. Although display 304 does not show this embodiment, channel 3 would be in sector I in place of channel 2 in this embodiment.

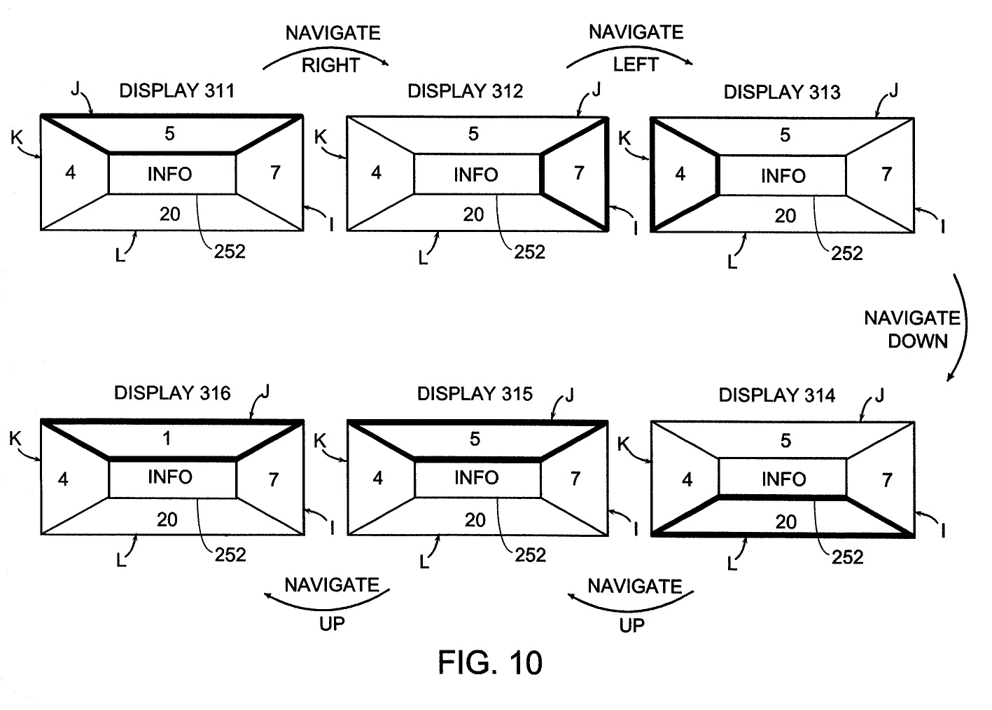

FIG. 10 shows the navigation of a second embodiment of the program guide 250 of FIG. 8. In the program guide 250 of FIG. 10, the center cell 252 is a dedicated cell that shows advertisements, messages, reminders, live programming, or other information. Each sector I, J, K, L, therefore, does not include the center cell 252, but instead only includes a single cell.

The user of display 311 in FIG. 10 can change from sector J to sector I by navigating to the right. Display 312 shows the result, with channel 7 selected in the cell of sector I. If the user of display 312 navigates to the left, sector K becomes selected, and channel 4 in the cell of sector K is highlighted. If the user of display 313 navigates down, the cell of sector J becomes selected, as is shown in display 314. If the user of display 314 navigates up, the cell of sector J becomes selected, as shown in display 315.

If the user of display 315 wishes to view additional channels within sector J, which contains the selected cell in display 315, the user can navigate toward the outer edge of that sector, or upward in display 315. Thus, if the user of display 315 navigates up, display 316 results, with a new channel, channel 1, appearing in sector J and with channel 5 disappearing.

In general, as has been described above, the program guides can be set up to be navigated in a number of methods. In addition, the shape of the display of the program guide, the number of sectors in a program guide, and the number of displayed cells within each sector can vary widely. The program listings can be displayed in a layout so that the user can navigate through the program listings in a non-linear manner. In other words, the user does not have to pan through channels in the order of the channels. Instead, the user is presented with a layout that breaks program listings into genres and allows the user to pan through genres. In some embodiments, a larger number of genres exist than the number of sectors in a layout of the program guide. In such an embodiment, the program guide can allow the user to pan through genres so that one or more genres are removed from the layout and replaced with other genres.

Any references to front and back, right and left, top and bottom, upper and lower, up or down, and horizontal and vertical are, unless noted otherwise, intended for convenience of description, not to limit the present invention or its components to any one positional or spatial orientation. All dimensions of the components in the attached Figures can vary with a potential design and the intended use of an embodiment without departing from the scope of the invention.

While the present invention has been described with reference to several embodiments thereof, those skilled in the art will recognize various changes that may be made without departing from the spirit and scope of the claimed invention. Accordingly, the invention is not limited to what is shown in the drawings and described in the specification, but only as indicated in the appended claims.

What is claimed is:

1. A method for presenting program information on a television screen, comprising:
displaying a plurality of sectors of program information in a layout, each sector in the layout relating to a different genre of program information, each sector spanning from a generally central area of the layout to a generally peripheral area of the layout, and each sector encompassing a plurality of program listings;
displaying at least one cell within each sector, each cell showing one of the program listings;
indicating that one of the cells in the layout is selected;
upon user interaction, panning between program listings within one of the sectors to indicate that a different program listing is selected; and
upon user interaction, panning between sectors of the layout.

2. The method of claim 1, wherein the layout is shaped as a rectangle with four sectors.

3. The method of claim 2, wherein the layout includes a center cell, the center cell being disposed within all of the sectors.

4. The method of claim 2, further comprising presenting advertising information in a center cell of the layout.

5. The method of claim 4, wherein each sector spans from the center cell to the generally peripheral area of the layout.

6. The method of claim 5, wherein each sector contains one cell.

7. The method of claim 1, wherein the layout is generally circular in shape.

8. The method of claim 7, further comprising presenting advertising information in a center cell of the layout.

9. The method of claim 8, wherein each sector spans from the center cell to the generally peripheral area of the layout.

10. The method of claim 7, wherein each sector contains a plurality of cells, wherein one of the cells within each sector is larger than the other cells in that sector.

11. The method of claim 10, wherein the larger cell within each sector is the only cell in that sector that can be selected.

12. The method of claim 7, wherein each sector is separated from adjacent sectors by lines extending radially from the generally central area of the layout to the generally peripheral area of the layout.

13. The method of claim 12, wherein the cells within each sector are separated by generally concentric circles positioned radially from the generally central area of the layout.

14. The method of claim 1, wherein panning between program listings includes keeping a common cell selected and rotating program listings into the common cell.

15. The method of claim 14, wherein each sector has a first cell and a second cell, the first cell being the selected cell, and wherein panning between program listings includes rotating one of the program listings from the second cell to the first cell and displaying a new program listing in the second cell.

16. The method of claim 1, wherein panning between program listings includes moving the selected cell from a first cell to a second cell within one of the sectors.

17. The method of claim 1, further comprising presenting an information box displaying further details about the program listing in the selected cell.

18. The method of claim 1, further comprising presenting a channel number within each cell of the layout.

19. The method of claim 1, further comprising presenting a program name within each cell of the layout.

20. The method of claim 1, further comprising presenting a genre name adjacent each sector of the layout.

21. An apparatus for presenting program information on a television screen, comprising:
a memory storing a program;
a processor in communication with the memory; in which the processor is directed by the program to:
display a plurality of sectors of program information in a layout, each sector in the layout relating to a different genre of program information, each sector spanning from a generally central area of the layout to a generally peripheral area of the layout, and each sector encompassing a plurality of program listings;
display at least one cell within each sector, each cell showing one of the program listings;
indicate that one of the cells in the layout is selected;
upon user interaction, pan between program listings within one of the sectors to indicate that a different program listing is selected; and
upon user interaction, pan between sectors of the layout.

22. An apparatus for presenting program information on a monitor, comprising:
circuitry that receives program information from a distribution facility, wherein the circuitry is configured to display the program information in a television program guide including:
a layout having a plurality of sectors of program information, each sector in the layout relating to a different genre of program information, each sector extending from a generally central area of the layout to a generally peripheral area of the layout, and each sector encompassing a plurality of program listings;
at least one cell organized and displayed within each sector, each cell displaying one of the program listings; and
an indicator that one of the cells in the layout is selected.

23. The apparatus of claim 22, wherein the layout includes a center cell, the center cell being disposed within all of the sectors.

24. The method of claim 22, wherein the layout includes a center cell presenting advertising information.

25. The method of claim 24, wherein each sector spans from the center cell to the generally peripheral area of the layout.

26. The method of claim 25, wherein each sector contains one cell.

27. The method of claim 22, wherein the layout is generally circular in shape.

28. The method of claim 27, wherein each sector is separated from adjacent sectors by lines extending radially from the generally central area of the layout to the generally peripheral area of the layout.

29. The method of claim 28, wherein the cells within each sector are separated by generally concentric circles positioned radially from the generally central area of the layout.

30. The method of claim 22, wherein panning between program listings includes keeping a common cell selected and rotating program listings into the common cell.

31. The method of claim 30, wherein each sector has a first cell and a second cell, the first cell being the selected cell, and wherein panning between program listings includes rotating one of the program listings from the second cell to the first cell and displaying a new program listing in the second cell.

32. The method of claim 22, wherein panning between program listings includes moving the selected cell from a first cell to a second cell within one of the sectors.

33. A method for presenting program information, comprising:
receiving program information for a television program guide from a distribution facility;
in response to the program information for a television program guide,
displaying a plurality of sectors of program information in a layout, each sector in the layout relating to a different genre of program information, each sector spanning from a generally central area of the layout to a generally peripheral area of the layout, and each sector encompassing a plurality of program listings;
displaying at least one cell within each sector, each cell showing one of the program listings;
indicating that one of the cells in the layout is selected;
upon user interaction, panning between program listings within one of the sectors to indicate that a different program listing is selected; and
upon user interaction, panning between sectors of the layout.

34. A method for providing program information, comprising:
transmitting information for a television program guide to a user, the television program guide including:
a layout having a plurality of sectors of program information, each sector in the layout relating to a different genre of program information, each sector extending from a generally central area of the layout to a generally peripheral area of the layout, and each sector encompassing a plurality of program listings;
at least one cell organized and displayed within each sector, each cell displaying one of the program listings; and
an indicator that one of the cells in the layout is selected.

35. A television program guide, comprising:
a layout having a plurality of sectors of program information, each sector in the layout relating to a different genre of program information, each sector extending from a generally central area of the layout to a generally peripheral area of the layout, and each sector encompassing a plurality of program listings;
at least one cell organized and displayed within each sector, each cell displaying one of the program listings; and
an indicator that one of the cells in the layout is selected.
